(19) United States
(12) Patent Application Publication
(10) Pub. No.: US 2017/0214039 A1
(43) Pub. Date: Jul. 27, 2017

(54) METHOD FOR CARBON COATING ON ELECTRODE ACTIVE MATERIAL OF LITHIUM ION BATTERY

(71) Applicants: JIANGSU HUADONG INSTITUTE OF LI-ION BATTERY CO., LTD., Suzhou (CN); TSINGHUA UNIVERSITY, Beijing (CN)

(72) Inventors: Shao-Jun Liu, Suzhou (CN); Li Wang, Beijing (CN); Jian-Jun Li, Beijing (CN); Xiang-Ming He, Beijing (CN); Jing Luo, Suzhou (CN); Cheng-Hao Xu, Beijing (CN); Yu-Ming Shang, Beijing (CN); Jian Gao, Beijing (CN); Yao-Wu Wang, Beijing (CN)

(73) Assignees: JIANGSU HUADONG INSTITUTE OF LI-ION BATTERY CO., LTD., Suzhou (CN); TSINGHUA UNIVERSITY, Beijing (CN)

(21) Appl. No.: 15/482,446

(22) Filed: Apr. 7, 2017

Related U.S. Application Data
(63) Continuation of application No. PCT/CN2015/091425, filed on Oct. 6, 2015.

(30) Foreign Application Priority Data
Oct. 14, 2014 (CN) 201410538896.9

(51) Int. Cl. H01M 4/1397; H01M 4/04; C09D 1/00; B05D 1/18; B05D 3/02; H01M 10/0525; H01M 4/58

(52) U.S. Cl. CPC H01M 4/1397; H01M 10/0525; H01M 4/0471; H01M 4/5825; B05D 1/18; B05D 3/0254; C09D 1/00

(57) ABSTRACT

A method for carbon coating on an electrode active material of a lithium ion battery is disclosed. The method comprises carrying out a liquid phase reaction of an electrode active material precursor in a first solvent, thereby obtaining a first mixture liquid comprising the first solvent, and a plurality of electrode active material particles dispersed in the first solvent; adding a carbon source into the first mixture liquid, thereby obtaining a second mixture liquid; drying the second mixture liquid, thereby obtaining a plurality of carbon source coated electrode active material particles; and sintering the plurality of carbon source coated electrode active material particles, thereby obtaining a plurality of carbon coated electrode active material particles.

### CROSS-REFERENCE TO RELATED APPLICATIONS

This application claims all benefits accruing under 35 U.S.C. §119 from China Patent Application No. 201410538896.9, filed on Oct. 14, 2014 in the State Intellectual Property Office of China, the content of which is hereby incorporated by reference. This application is a continuation under 35 U.S.C. §120 of international patent application PCT/CN2015/091425 filed on Oct. 06, 2015, the content of which is also hereby incorporated by reference.

### FIELD

The present disclosure relates to lithium ion batteries, especially to methods for carbon coating on electrolyte active materials of lithium ion batteries.

### BACKGROUND

Properties of a cathode active material or an anode active material can greatly affect the performance of a lithium ion battery. Therefore, research and development of electrode active materials with excellent properties are very important to the application of the lithium ion battery.

The common cathode active materials (such as layer type lithium cobalt oxide, layer type lithium nickel oxide, spinel type lithium manganese oxide, olivine type lithium iron phosphate, and modification materials thereof), and the common anode active materials (such as lithium titanate) both have low electrical conductivities. To improve the electrical conductivities, two kinds of methods including refining the electrode active materials (such as preparing nanosized electrode active material particles), and carbon coating on the electrode active materials are commonly used.

The nanosized electrode active material particles which have special morphologies and excellent electrochemical performances can be obtained by a liquid phase reaction such as a hydrothermal method, a solvothermal method, a coprecipitation method, a supercritical hydrothermal method, and a microwave synthesis method. In a common method for the carbon coating on the nanosized electrode active material particles to further improve the electrical conductivities, a dry powder of the nanosized electrode active material particles and a carbon source are mixed and then sintered. However, if the dry powder of the nanosized electrode active material particles and the carbon source are mixed by ball-milling or grinding, not only are the morphologies of the nano sized electrode active material particles destroyed, but also the nanosized electrode active material particles are aggregated, which diminishes the advantages of the nanosized electrode active material particles. If the dry powder of the nanosized electrode active material particles is dispersed in a carbon source solution, the nanosized electrode active material particles aggregate due to a high surface energy of each of the nanosized electrode active material particles. This decreases the dispersibility of the nanosized electrode active material particles in the carbon source solution, thereby diminishing the advantages of the nanosized electrode active material particles.

### BRIEF DESCRIPTION OF THE DRAWINGS

Implementations are described by way of example only with reference to the attached figures.

FIG. 1 is a flow chart of one embodiment of a method for carbon coating an electrode active material of a lithium ion battery.

FIG. 2 shows a scanning electron microscope (SEM) photo of Example 1 of carbon coated LiFePO₄ cathode active material particles.

FIG. 3 is a graph showing charge and discharge curves of Example 1 and Comparative Example 1 of carbon coated LiFePO₄ cathode active material particles.

### DETAILED DESCRIPTION

A detailed description with the above drawings is made to further illustrate the present disclosure.

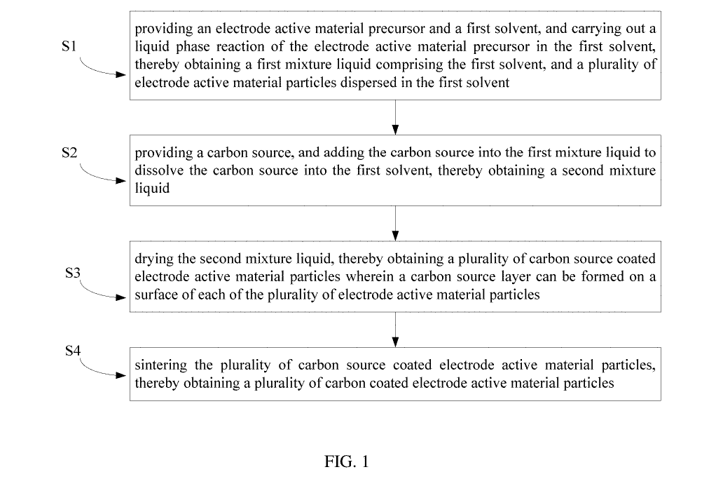

Referring to FIG.1, one embodiment of a method for carbon coating an electrode active material of a lithium ion battery comprises the following steps of:

S1, providing an electrode active material precursor and a first solvent, and carrying out a liquid phase reaction of the electrode active material precursor in the first solvent, thereby obtaining a first mixture liquid comprising the first solvent, and a plurality of electrode active material particles dispersed in the first solvent;

S2, providing a carbon source, and adding the carbon source into the first mixture liquid to dissolve the carbon source into the first solvent, thereby obtaining a second mixture liquid;

S3, drying the second mixture liquid, thereby obtaining a plurality of carbon source coated electrode active material particles wherein a carbon source layer can be formed on a surface of each of the plurality of electrode active material particles; and

S4, sintering the plurality of carbon source coated electrode active material particles, thereby obtaining a plurality of carbon coated electrode active material particles.

In S1, the electrode active material particles can be cathode active material particles, or anode active material particles. The cathode active material particles can be at least one of spinel type lithium manganese oxide, layer type lithium manganese oxide, lithium nickel oxide, lithium cobalt oxide, lithium iron phosphate, lithium nickel manganese oxide, and lithium cobalt nickel manganese oxide, and the oxides can be doped with other chemical elements. The spinel type lithium manganese oxide can be represented by a chemical formula of LiₘMn₂₋ₙLₙO₄. The layer type lithium manganese oxide can be represented by a chemical formula of LiₘMn₁₋ₙLₙO₂. The lithium nickel oxide can be represented by a chemical formula of LiₘNi₁₋ₙLₙO₂. The lithium cobalt oxide can be represented by a chemical formula of LiₘCo₁₋ₙLₙO₂. The lithium iron phosphate can be represented by a chemical formula of LiₘFe₁₋ₙLₙPO₄. The lithium nickel manganese oxide can be represented by a chemical formula of LiₘNi_{0.5+z-a}Mn_{1.5-z-b}LₐR_{b}O₄. The lithium cobalt nickel manganese oxide can be represented by a chemical formula of LiₘNi_{c}Co_{d}MnₑL_{f}O₂.0.1≦m≦1.1, 0≦n<1, 0≦z<1.5, 0≦a-z<0.5, 0≦b+z<1.5, 0<c<1, 0<d<1, 0<e<1, 0≦f≦0.2, and c+d+e+f=1. L and R can be selected from at least one of alkali metal elements, alkaline earth metal elements, group 13 elements, group 14 elements, transition metal elements, and rare earth elements, such as at least one of Mn, Ni, Cr, Co, V, Ti, Al, Fe, Ga, Nd, and Mg.

The anode active material particles can be at least one of lithium titanate, titanium dioxide, and cobaltosic oxide (i.e., cobalt (ILM) oxide, Co₃O₄). The lithium titanate can be doped or non-doped lithium titanate. The doped or non-doped lithium titanate can have a spinel structure. The non-doped lithium titanate can be represented by a chemical formula of Li₄Ti₅O₁₂. The doped lithium titanate can be represented by a chemical formula of Li_{(4-g)}A_{g}Ti₅O₁₂orLi₄AₕTi₍₅₋ₕ₎O₁₂, wherein 0<g≦0.33, and 0<h≦0.5, and the element A can be selected from at least one of alkali metal elements, alkaline earth metal elements, group 13 elements, group 14 elements, transition metal elements, and rare earth elements, such as at least one of Mn, Ni, Cr, Co, V, Al, Fe, Ga, Nd, Nb and Mg.

The electrode active material precursor can comprise raw materials which are essential reactants to produce the plurality of electrode active material particles by the liquid phase reaction. The electrode active material precursor can be selected according to the plurality of electrode active material particles to be prepared and the specific type of the liquid phase reaction. In one embodiment, to prepare a plurality of lithium iron phosphate cathode active material particles by a solvothermal method, the electrode active material precursor can comprise a lithium source, a ferrous source, and a phosphate radical source.

The first solvent can be a reaction medium of the liquid phase reaction. The first solvent can be selected from at least one of water, ethanol, ethylene glycol, glycerol, diethylene glycol, triethylene glycol, tetraethylene glycol, butanetriol, n-butanol, isobutanol, polyethylene glycol, and dimethyl formamide.

The liquid phase reaction can be selected from a hydrothermal method, a solvothermal method, a coprecipitation method, a supercritical hydrothermal method, and a microwave synthesis method, which are carried out in a liquid phase environment to prepare the plurality of electrode active material particles. A plurality of nanosized electrode active material particles can be directly produced in the first solvent during the liquid phase reaction, with excellent dispersibility and uniformity of the plurality of nanosized electrode active material particles in the first mixture liquid. The first mixture liquid can be a suspension liquid.

The first mixture liquid can comprise unreacted ionic impurities which would be introduced into the plurality of carbon coated electrode active material particles if not removed. The unreacted ionic impurities can be removed from the first mixture liquid by the following steps of:

S11, obtaining a first wet powder by separating the plurality of electrode active material particles from the first mixture liquid but not drying or evaporating, and obtaining a second wet powder by washing the first wet powder with a second solvent, filtering, but not drying or evaporating; and

S12, dispersing the second wet powder in the first solvent, thereby obtaining the first mixture liquid substantially without the unreacted ionic impurities.

In S11, the first wet powder can comprise the plurality of electrode active material particles, the first solvent, and the unreacted ionic impurities. The first solvent and the unreacted ionic impurities can be absorbed on the surface of each of the plurality of electrode active material particles. The second wet powder can comprise the plurality of electrode active material particles, and the second solvent adsorbed on the surface of each of the plurality of electrode active material particles.

The first wet powder can be washed with the second solvent, and filtered several times. The unreacted ionic impurities can be dissolved in the second solvent, and thus are removed by the second solvent in the process of washing and filtering. The first solvent and the second solvent can be soluble to each other at any proportion. The second solvent can be selected from water, ethanol, ethylene glycol, glycerol, diethylene glycol, triethylene glycol, tetraethylene glycol, butanetriol, n-butanol, isobutanol, polyethylene glycol, dimethyl formamide, and combinations thereof. The second solvent can be the same as the first solvent.

In S12, because the first solvent or the second solvent is absorbed on the surface of each of the plurality of electrode active material particles, a surface energy of each of the plurality of electrode active material particles can be greatly decreased, thereby decreasing the aggregation of the plurality of electrode active material particles in the first wet powder or in the second wet powder. In one embodiment, a solid content of the first wet powder and a solid content of the second wet powder are each less than about 50%, such as less than about 40%, thereby maintaining the lower surface energy of each of the plurality of electrode active material particles, and obtaining the first mixture liquid substantially without the unreacted ionic impurities with excellent dispersibility and uniformity.

In S2, the carbon source can be dissolved in the first solvent. The carbon source can be at least one of glucose, sucrose, fructose, lactose, starch, and polymer such as polyvinyl chloride, polyvinyl alcohol, polyvinyl butyral, polyvinyl pyrrolidone, polyacrylonitrile, and phenolic resin. The carbon source can be evenly distributed around each of the plurality of electrode active material particles when dissolved into the first solvent. An amount of the carbon source can be determined according to a thickness of the carbon layer. A mass ratio of the carbon source to the plurality of electrode active material particles in the first mixture liquid can be in a range from about 10% to about 300%, such as from about 20% to about 200%.

In S3, in the process of drying, the carbon source layer is formed by the carbon source on the surface of each of the plurality of electrode active material particles. Due to a steric hindrance effect of the carbon source layer, the plurality of carbon source coated electrode active material particles cannot be aggregated together, thereby maintaining the monodispersity and uniformity of the plurality of nanosized electrode active material particles.

The second mixture liquid can be dried or evaporated by a variety of ways, such as natural drying, oven drying, vacuum drying, microwave drying, and spray drying. A drying temperature can be in a range from about 100° C. to about 150° C., during which not only the first solvent can be volatilized quickly, but the carbon source cannot decompose.

In S4, the plurality of carbon source coated electrode active material particles can be sintered in an inert gas. A sintering temperature is not limited as long as the carbon source can be cracked into elemental carbon. In one embodiment, the sintering temperature can be in a range from about 400° C. to about 1000° C., such as from about 600° C. to about 750° C. A sintering time can be in a range from about 2 hours to about 10 hours.

In the process of sintering, the carbon source can be cracked into elemental carbon, and the carbon source layer can be transformed to the continuous and uniform carbon layer on the surface of each of the plurality of electrode active material particles, thereby obtaining the plurality of carbon coated electrode active material particles with excellent dispersibility and uniformity. Thus, not only the advantages of the plurality of nanosized electrode active material particles are maintained, but the electrical conductivity of the plurality of nanosized electrode active material particles is further improved.

### EXAMPLE 1

80 mL of ethylene glycol and 4.19 g of lithium hydroxide monohydrate are mixed by stirring for 60 minutes, and then 1.63 ml of phosphoric acid is added to obtain a uniform white solution A. 100 mL of ethylene glycol and 8.34 g of ferrous sulfate are mixed by stirring for 60 minutes to obtain a uniform solution B. The solution B is added into the white solution A drop by drop, stirred for 30 minutes, sealed into a solvothermal reactor having a polytetrafluoroethylene lining, and heated at 180° C. for 10 hours to obtain a first mixture liquid wherein a plurality of LiFePO₄ cathode active material particles are uniformly dispersed in the ethylene glycol.

Glucose is added to the first mixture liquid, and dissolved into the ethylene glycol by stirring for 0.5 hour to 2 hours to obtain a second mixture liquid, wherein the mass of the glucose is 20% of the mass of the plurality of LiFePO₄ cathode active material particles. The second mixture liquid is vacuum dried at 120° C. to obtain a plurality of glucose coated LiFePO₄ cathode active material particles. The plurality of glucose coated LiFePO₄ cathode active material particles are sintered at 600° C. to 750° C. in a nitrogen gas for 2 hours to 10 hours to obtain a plurality of carbon coated LiFePO₄ cathode active material particles.

### COMPARATIVE EXAMPLE 1

The method in Comparative Example 1 is substantially the same as the method in Example 1, except that after obtaining the first mixture liquid, the first mixture liquid is washed with water and anhydrous alcohol, centrifugal separated, and vacuum dried at 80° C. to obtain a dry powder.

The glucose is dissolved into an ethanol water solution to obtain a solution C, wherein a mass ratio of ethanol to water is 4:1, and the mass of the glucose is 20% of the mass of the dry powder. The dry powder is dispersed in the solution C to obtain a second mixture liquid. The second mixture liquid is dried to obtain a plurality of glucose coated LiFePO₄ cathode active material particles. The plurality of glucose coated LiFePO₄ cathode active material particles are sintered at 600° C. to 750° C. in a nitrogen gas for 2 hours to 10 hours to obtain a plurality of carbon coated LiFePO₄ cathode active material particles.

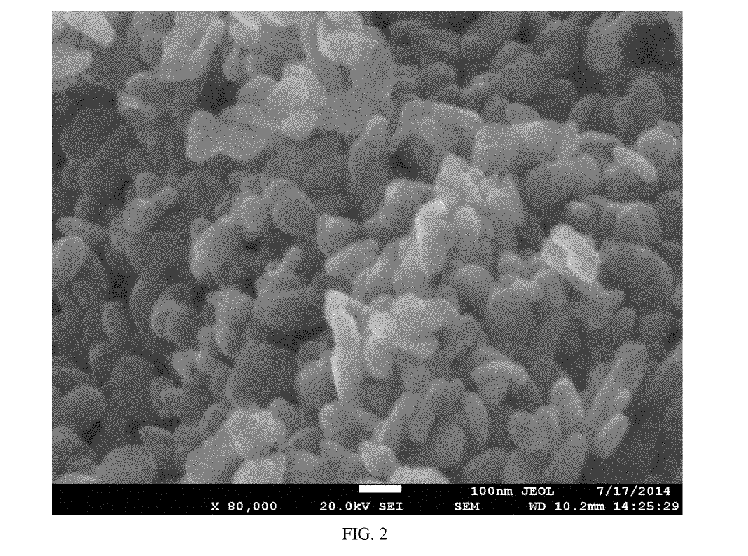

FIG. 2 shows a scanning electron microscope (SEM) photo of Example lofthe carbon coated LiFePO₄ cathode active material particles. It can be seen from FIG. 2 that the dispersibility and the uniformity of the carbon coated LiFePO₄ cathode active material particles are excellent.

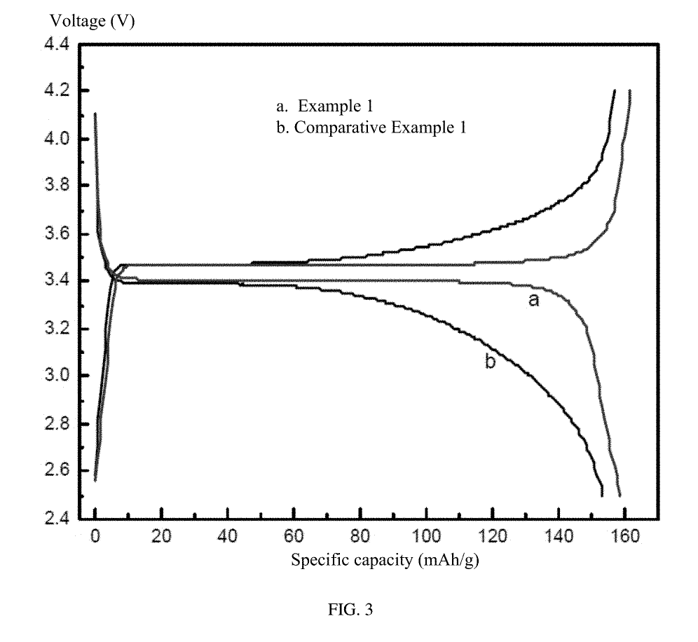

FIG. 3 is a graph showing charge and discharge curves of Example 1, and Comparative Example 1 of the carbon coated LiFePO₄ cathode active material particles at a charge and discharge rate of 0.2 C. It can be seen from FIG. 3 that compared to the carbon coated LiFePO₄ cathode active material particles in Comparative Example 1, the specific capacity, the median voltage, and the specific energy thereof are higher, the cycling performance thereof is better, and the polarization thereof is smaller in Example 1.

In the present disclosure, a carbon source is directly dissolved into an untreated mixture liquid produced from a liquid phase reaction wherein a plurality of electrode active material particles are dispersed, thereby avoiding aggregations of the plurality of electrode active material particles in a common method to mix a dry powder of the plurality of electrode active material particles and the carbon source. Thus, a plurality of carbon coated electrode active material particles with good monodispersity, well uniformity, excellent electrical conductivity, and improved electrochemical performance are obtained.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. A method for carbon coating an electrode active material of a lithium ion battery, comprising:
providing an electrode active material precursor and a first solvent, and carrying out a liquid phase reaction of the electrode active material precursor in the first solvent, thereby obtaining a first mixture liquid comprising the first solvent, and a plurality of electrode active material particles dispersed in the first solvent;
providing a carbon source, and adding the carbon source into the first mixture liquid to dissolve the carbon source into the first solvent, thereby obtaining a second mixture liquid;
drying the second mixture liquid, thereby obtaining a plurality of carbon source coated electrode active material particles wherein a carbon source layer is formed on a surface of each of the plurality of electrode active material particles; and
sintering the plurality of carbon source coated electrode active material particles, thereby obtaining a plurality of carbon coated electrode active material particles.

2. The method of claim 1, unreacted ionic impurities in the first mixture liquid are removed by:
obtaining a first wet powder by separating the plurality of electrode active material particles from the first mixture liquid but not drying, and obtaining a second wet powder by washing the first wet powder with a second solvent, filtering, but not drying; and
dispersing the second wet powder in the first solvent, thereby obtaining the first mixture liquid substantially without the unreacted ionic impurities.

3. The method of claim 2, wherein the first wet powder comprises the plurality of electrode active material particles, the first solvent and the unreacted ionic impurities, the first solvent and the unreacted ionic impurities are absorbed on the surface of each of the plurality of electrode active material particles, and the second wet powder comprises the plurality of electrode active material particles, and the second solvent adsorbed on the surface of each of the plurality of electrode active material particles.

4. The method of claim 2, wherein the unreacted ionic impurities are dissolved in the second solvent.

5. The method of claim 2, wherein the first solvent and the second solvent are soluble to each other at any proportion.

6. The method of claim 2, wherein the second solvent is the same as the first solvent.

7. The method of claim 2, wherein the second solvent is selected from the group consisting of water, ethanol, ethylene glycol, glycerol, diethylene glycol, triethylene glycol, tetraethylene glycol, butanetriol, n-butanol, isobutanol, polyethylene glycol, dimethyl formamide, and combinations thereof.

8. The method of claim 2, wherein solid contents of the first wet powder and the second wet powder are smaller than about 50%.

9. The method of claim 1, wherein the electrode active material precursor comprises raw materials which are essential reactants to produce the plurality of electrode active material particles by the liquid phase reaction.

10. The method of claim 1, wherein the first solvent is selected from the group consisting of water, ethanol, ethylene glycol, glycerol, diethylene glycol, triethylene glycol, tetraethylene glycol, butanetriol, n-butanol, isobutanol, polyethylene glycol, dimethyl formamide, and combinations thereof.

11. The method of claim 1, wherein the liquid phase reaction is a hydrothermal method, a solvothermal method, a coprecipitation method, a supercritical hydrothermal method, or a microwave synthesis method.

12. The method of claim 1, wherein the carbon source is selected from the group consisting of glucose, sucrose, fructose, lactose, starch, polyvinyl chloride, polyvinyl alcohol, polyvinyl butyral, polyvinyl pyrrolidone, polyacrylonitrile, phenolic resin, and combinations thereof.

13. The method of claim 1, wherein a mass ratio of the carbon source to the plurality of electrode active material particles in the first mixture liquid is in a range from about 10% to about 300%.

14. The method of claim 1, wherein a drying temperature of the second mixture liquid is in a range from about 100° C. to about 150° C.

15. The method of claim 1, wherein the plurality of carbon source coated electrode active material particles are sintered in an inert gas.

16. The method of claim 1, wherein the plurality of carbon source coated electrode active material particles are sintered at a temperature range from about 400° C. to about 1000° C. for about 2 hours to about 10 hours.
